(19) United States
(12) Patent Application Publication
(10) Pub. No.: US 2012/0109840 A1
(43) Pub. Date: May 3, 2012

(54) DONOR DRIVEN RESEARCH SELECTION AND FUNDING METHOD AND SYSTEM

(76) Inventor: Inhan Lee, Ann Arbor, MI (US)

(21) Appl. No.: 13/283,895

(22) Filed: Oct. 28, 2011

Related U.S. Application Data
(60) Provisional application No. 61/407,674, filed on Oct. 28, 2010.

(51) Int. Cl. G06Q 99/00

(52) U.S. Cl. 705/329

(57) ABSTRACT

An online Internet-based method for funding scientific research comprises presenting a plurality of candidate research projects to potential or executing donors for the donors' review. The potential or executing donors view the candidate research projects on a computer system using a web browser. Donations are received from executing donors. Selections are received from the executing donors regarding research projects to be funded. Finally, funding is provided to a research project. A system that implements the method is also provided.

### CROSS-REFERENCE TO RELATED APPLICATIONS

This application claims the benefit of U.S. provisional Application No. 61/407,674 filed Oct. 28, 2010, the disclosure of which is incorporated in its entirety by reference herein.

### FIELD OF THE INVENTION

The present invention relates in general to methods and systems for eliciting donor input for funding scientific research.

### BACKGROUND

Scientific research is typically funded by federal or private grants. Decisions regarding selection of programs to fund as typically made of panel of scientists. The general public rarely ever directly participates in the selection of programs to be funded even though they may be the ultimate source of the funding.

Accordingly, there is a need to methods of funding scientific research which takes into account input from the general public.

### SUMMARY OF THE INVENTION

In an embodiment, an online Internet-based method for funding scientific research is provided. The method comprises presenting a plurality of candidate research projects to potential or executing donors for the donors' review. The potential donors view the candidate research projects on a computer system using a web browser. Donations are received from executing donors. Selections are received from the executing donors regarding research projects to be funded. Finally, funding is provided to a research project.

In another embodiment, an online Internet-based system for funding scientific research is provided. The system includes a computer system operable to present a plurality of candidate research projects to potential or executing donors for the donors' review. The potential or executing donors view the candidate research projects on a computer system using a web browser. The computer system is further operable to receive donation pledges or donations from executing donors and to receive selections from the executing donors regarding research projects to be funded. The computer system is also operable to provide executing donor selections to a person or committee.

### BRIEF DESCRIPTION OF THE DRAWINGS

The invention, both as to its exemplary organization and illustrative manner of operation, together with further objects and advantages thereof, may best be understood with reference to the following description, taken in connection with the accompanying drawings, in which:

FIG. 1 is a schematic of a system for providing funding scientific research;

FIG. 2 is a schematic of an example of a system for funding scientific research; and

FIG. 3 provides an example of an infrastructure for public-driven standardized RNA biomarker discovery centered around microRNAs.

### DETAILED DESCRIPTION OF THE INVENTION

Reference will now be made in detail to presently preferred compositions, embodiments and methods of the present invention which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

In an embodiment, an Internet-based method for funding scientific research is provided. The method comprises presenting a plurality of candidate research projects to potential or executing (i.e., have already made a donation) donors for the donors' review. The potential or executing donors view the candidate research projects on a computer system using a web browser. Donations are received from executing donors. Selections are received from the executing donors regarding research projects to be funded. Finally, funding is provided to a research project.

In a variation of the present embodiment, the method further comprises receiving input from the potential donors regarding research areas of interest to the executing donors. If predetermined criteria are met, a research project is created to be included in the plurality of candidate research projects.

In a variation of the present embodiment, the method further comprises allowing donors to cast votes for one or more research projects to be funded. In a refinement, an amount of funding for each research project is proportional to the number of votes cast for each research project.

In another variation, a selected research project is funded when a predetermined level of funding designating the selected research project has been received. The research proposals are evaluated from investigators to be included in the plurality of candidate research projects.

In still another variation, a selected research project is provided a predetermined amount of funding after the predetermined amount of funding has been received.

In yet another variation, the method further comprises providing scientific information to a requesting user (donors, investigators, the general public, etc). Such information may include the results of research funded by the present embodiment.

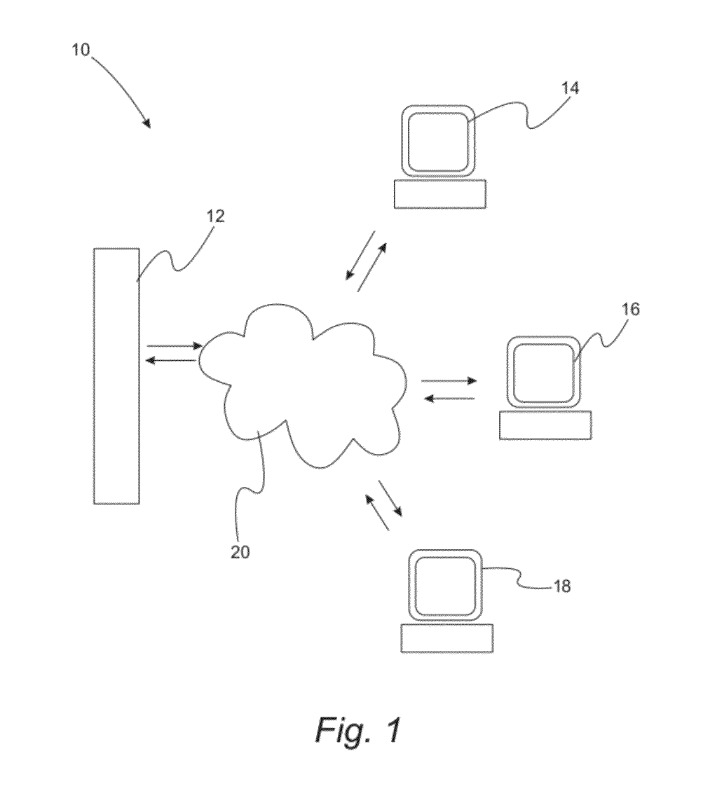

With reference to FIG. 1, a system for providing funding of scientific research is provided. System 10 includes server 12 communicating with users over the Internet. Users communicate using network enabled devices 14, 16, 18 over the Internet 20. Typically, server 12 includes one or more computers or computer processors, random access memory, and data storage devices (e.g., hard drives, optical drives, CDs, DVDs, and the like). Examples of network enabled devices include, but are not limited to, personal computers, IPads™, IPhones™, Blackberry™ devices, other handheld devices and the like. Server 12 is operable to perform one or more (or all) of the steps of the method for funding scientific research. Specifically, server 12 executes the step of presenting a plurality of candidate research projects to potential or executing donors (i.e., users) for the donors' review. Donors include not only individual providing money but also equipment, scientific know-how, and the like. The potential or executing donors view the candidate research projects on a computer system such that the candidate research projects are viewable within a web browser. Server 12 also receives donations (or pledges for donations) from executing donors. In the present context, an “executing donor” is a user making a pledge of a donation or actually making a donation (i.e., via credit card, check, etc). Server 12 receives selections from the executing donors regarding research projects to be funded (which projects the executing donor wants funded). Server 12 subsequently provides executing donor selections to a person or committee that directs disbursement of funding. Finally, funding is provided to a research project. The level of funding is a function of the number of votes received or equal to a predetermined amount.

In a variation of the present embodiment, server 12 is further operable to receive input from the potential donors regarding research areas of interest to the executing donors. If predetermined criteria are met, a research project is created to be included in the plurality of candidate research projects.

In a variation of the present embodiment, server 12 is further operable to allow donors to cast votes for one or more research projects to be funded. In a refinement, an amount of funding for each research project is proportional to the number of votes cast for each research project. In a refinement, the executing donor may receive a number of votes depending on the amount of the executing donor's donation.

In yet another variation, server 12 is further operable to provide scientific information to a requesting user (donors, investigators, the general public, etc). Such information may include the results of research funded by the present embodiment.

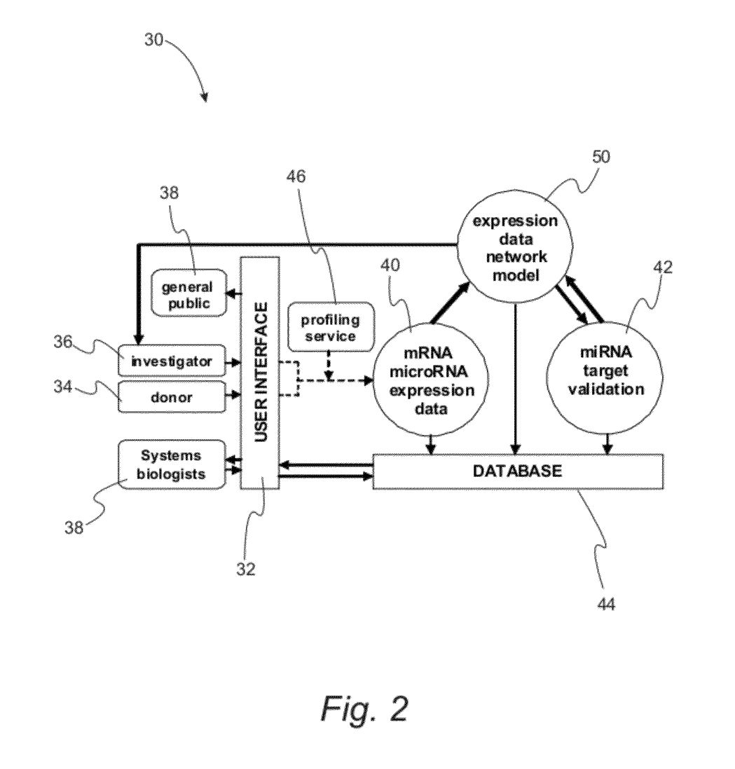

With reference to FIG. 2, a schematic representation of an example of a system for funding scientific research and exchanging scientific information is provided. In this example, system 30 provides an interface 32 for allowing potential donors 34 and investigators 36 to access the system. Typically, this interface is presented over the Internet with users utilizing a web browser. The interface also allows the general public 38 to access at least some information. In a refinement, other users (i.e., systems biologists) can access information through interface 32. For example, in the specific example of FIG. 2, users can access mRNA and miRNA expression patterns (item 40). The system also allows for validation of miRNA targets (item 42). This information is stored in database 44. In such situations, services 46 (e.g., expression profiling) are used internally to address the request information. In a variation, the requested data is integrated into a model to be presented to the requesting investigator (item 50).

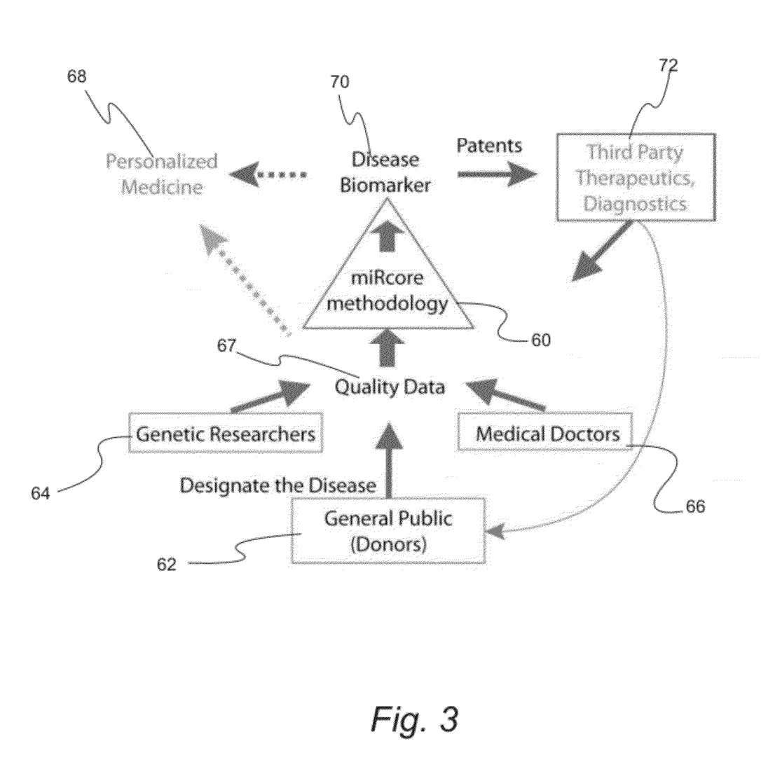

With reference to FIG. 3, an example of an infrastructure for public-driven standardized RNA biomarker discovery centered around microRNAs, newly-identified genetic elements which essentially work as gate-keepers to gene function by stopping protein production of other genes is provided. The advantages of studying microRNAs are 1) their manageable number (about 1,000, as opposed to 23,000 protein producing genes), 2) their function as potential master regulators, 3) their detectability even in urine, 4) their potential as early markers, prior to symptoms, and 5) their manipulability. FIG. 3 shows an example of using bioinformatics methodology (such as that provided by miRcore, company located in Ann Arbor, MI) (item 60) for microRNA-centric research infrastructure which generates new hypotheses and biomarkers to address a range of health problems. Such technology is found in U.S. Pat. Appl. No. 13032377 filed Feb. 22, 2011 and PCT Appl. No. PCT/US11/25726 filed Feb. 22, 2011, the enteric disclosures of awhich are hereby incorporated by reference. With this infrastructure, the collective demands of many individuals (from among the general public) (item 62) will steer biomedical investigation. When specific disease research (e.g., Alzheimer's disease) is initiated by individuals, the initial screening process will identify potential collaborators (researchers and doctors—items 64 and 66) in the field, define the most relevant questions (ex: what deterministic RNA changes in Alzheimer's disease might be usable in blood screening?), and determine feasibility. Once initiated, fundraising will commence through the website. Meanwhile, research samples can be identified through collaborators (e.g., blood from 20 patients with Alzheimer's disease and 20 matching control participants). After fundraising, RNA profiles of all the samples will be obtained in compliance with HIPPA and the collaborator's institutional Internal Regulation Board. The obtained data (item 67) can be used by the internal group to analyze for biomarkers (item 70) that can be used for personalized medicine (item 68). The data (item 70) can also be used as a resource available through the website. Patentable biomarkers will be filed and licensed to third parties for product development (item 72).

The process is scalable and applicable to all diseases. Note that each project will deal with identical cell types, data formats, and experimental platforms, making accumulated data across diseases usable for future analysis. The data can be made available to researchers in a systematic way. The first step is agreement between collaborators in sharing data with other scientists. The second safeguard will be a data access system only to members who agree on confidentiality. After a certain period, access to data can be increased. In this way, a collaborative medical research network will be built.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for funding scientific research, the method comprising:
presenting a plurality of candidate research projects to potential or executing donors for the donors' review, the potential donors viewing the candidate research projects on a computer system;
receiving donation pledges or donations from executing donors;
receiving selections from the executing donors regarding research projects to be funded; and
providing funding to a research project, the level of funding being a function of the number of votes received or being equal to a predetermined amount.

2. The method of claim 1 further comprising receiving input from the potential donors regarding research areas of interest to the executing donors.

3. The method of claim 1 further comprising creating a research project to be included in the plurality of candidate research projects.

4. The method of claim 1 wherein the executing donor is allowed to cast votes for one or more research projects to be funded.

5. The method of claim 1 wherein an amount of funding for each research project is proportional to the number of votes cast for each research project.

6. The method of claim 5 wherein a selected research project is funded when a predetermined level of funding designating the selected research project has been received.

7. The method of claim 1 further comprising evaluating research proposals from investigators to be included in the plurality of candidate research projects.

8. The method of claim 1 wherein a selected research project is provided a predetermined amount of funding after the predetermined amount of funding has been received.

9. The method of claim 1 wherein the potential or executing donors view the candidate research projects and make selections using a web browser.

10. The method of claim 1 further comprising providing scientific information to a requesting user.

11. An online system for funding scientific research, the system comprising a computer system operable to:
present a plurality of candidate research projects to potential or executing donors for the donors' review, the potential donors viewing the candidate research projects on a computer system;
receive donation pledges or donations from executing donors;
receive selections from the executing donors regarding research projects to be funded; and
provide executing donor selections to a person or committee.

12. The system of claim 11 wherein the computer system is further operable to receive input from the potential donors regarding research areas of interest to the executing donors.

13. The system of claim 11 wherein the computer system is further operable to receive votes from the executing donor regarding one or more research projects to be funded.
